(19) United States
(12) Patent Application Publication
(10) Pub. No.: US 2025/0241276 A1
(43) Pub. Date: Jul. 31, 2025

(54) PET HEALTH MONITORING SYSTEM FOR PROACTIVE MEDICINE

(71) Applicant: MAVEN PET INC., Newark, DE (US)

(72) Inventors: David Barroso, Porto (PT); Guilherme Coelho, Porto (PT); Joana Babo, Newark, DE (US); Carlos Miguel Brandão Pereira, Newark, DE (US); Pedro Miguel Marinho Almeida, Newark, DE (US); Rui Pedro dos Santos Correia, Newark, DE (US); Rafael Soares, Newark, DE (US)

(21) Appl. No.: 19/028,951

(22) Filed: Jan. 17, 2025

Related U.S. Application Data
(60) Provisional application No. 63/625,510, filed on Jan. 26, 2024.
(60) Provisional application No. 63/625,360, filed on Jan. 26, 2024.

(51) Int. Cl. A01K 29/00

(52) U.S. Cl. CPC A01K 29/005

(57) ABSTRACT

A health monitoring system for a pet includes a monitoring device for monitoring a health status of the pet and a computing platform in communication with the monitoring device. The computing platform has a processor and a first memory on which health modules including tangible, non-transitory, processor executable instructions are stored. The health modules are configured to receive and interpret health data. An artificial intelligence application is in communication with the computing platform and configured to receive the health data and detect a health event. The artificial intelligence application includes a second memory configured to store the health data and the health event. A user interface is in communication with the computing platform and the artificial intelligence application.

### CROSS-REFERENCE TO RELATED APPLICATIONS

This application claims the benefit of U.S. Provisional Application No. 63/625,510 filed on Jan. 26, 2024, and U.S. Provisional Application No. 63/625,360 filed on Jan. 26, 2024. The entire disclosures of the above applications are incorporated herein by reference.

### FIELD

The present technology relates to pet health monitoring, specifically, artificial intelligence pet health monitoring as well as preventative and proactive medicine.

### INTRODUCTION

This section provides background information related to the present disclosure which is not necessarily prior art.

The veterinary industry is under pressure due to the high demands of pet owners seeking the best and most personalized healthcare for their pets. Adding to the complexity of pet healthcare, the number of pets per household has been increasing over the past years, a trend that became even more pronounced during the pandemic years. It is impossible for veterinarians and support staff, including nurses and technicians, to provide around the clock care for pets due to the overwhelming number of cases they see on a daily basis. Additionally, veterinarians and support staff often have to rely on unreliable data provided by pet owners to cover time periods during which a pet is not in the care of the veterinarian. Veterinarians and support staff may find themselves overwhelmed and struggling to provide high-quality healthcare for a variety of reasons.

Pet owners also often fall short with respect to understanding and reacting to the specific needs of their pets. Perhaps most notably, pet owners typically do not have equipment capable of reliably collecting basic health data for their pet, such as body temperature and respiratory rate, as examples. This can make it difficult for pet owners to know for certain whether a pet is experiencing a health issue. Additionally, pet owners often lack the expertise and do not have access to on demand pet healthcare provider advice when issues arise. Even when a pet owner has health data for a pet, it may still be difficult for pet owners to interpret the health data and understand what is considered normal, both for the pet and for a general population of animals.

Monitoring pet health data using data collection, statistics, and patterns may be an important part of effective pet care. Additionally, collecting health data consistently over a desired period of time allows both veterinarians and pet owners to better understand what is normal and abnormal for a pet. Accurate, detailed data collection can assist in early detection, prevention, and treatment of various medical conditions. However, the collection of health data does not automatically translate into effective medical care. Rather, it is equally as important to effectively analyze the data and compare the data to the pet's data history as well as health data from general and/or specific pet populations.

Pet health metrics, such as heart rate, blood pressure, and glucose levels, can be collected using equipment and wearable devices in specialized settings. While these tools offer valuable insights into pet health data, their true potential is realized when the data collected is thoroughly analyzed and emerging patterns from the data are understood. Preventative medicine as well as disease management can require proactive measures based on interpretation of health data and associated trends and patterns. For instance, identifying a consistent increase in heart rate over time could prompt lifestyle modifications or early interventions to mitigate the risk of cardiovascular disease in a pet. If health stats are never collected or left unexamined, these warning signs may go unnoticed, allowing potential health issues to escalate without treatment. Accordingly, it would be desirable for advancing technology to provide a means for collecting health data over selected periods of time and present the health data in such a way as to allow both pet healthcare providers and pet owners to understand the health data and implement changes to improve pet health.

Accordingly, there is a need for a pet health monitoring system that can include around the clock pet health monitoring that is easy to use for veterinarians and pet owners and that is capable of collecting, analyzing, and comparing pet health data for a pet compared to larger populations of pets. The health monitoring system may benefit from the use of one or more artificial intelligence applications to optimize use of the pet health data to improve pet quality of life during healthy years as well as when a pet is experiencing illness.

### SUMMARY

In concordance with the instant disclosure, a pet health monitoring system that includes around the clock pet health monitoring that is easy to use for veterinarians and pet owners, is capable of collecting, analyzing, and comparing pet health data for a pet compared to larger populations of pets, and uses artificial intelligence applications to optimize use of the pet health data to improve pet quality of life during healthy years, as well as when a pet is experiencing illness, has surprisingly been discovered.

The present technology includes articles of manufacture, systems, and processes that relate to a pet health monitoring system.

In certain embodiments, a health monitoring system for a pet includes a monitoring device for monitoring a health status of the pet and a computing platform in communication with the monitoring device. The computing platform includes a processor and a first memory on which one or more health modules including tangible, non-transitory, processor executable instructions are stored. The health modules are configured to receive and interpret health data. An artificial intelligence application is in communication with the computing platform and configured to receive the health data and detect a health event. The artificial intelligence application includes a second memory configured to store the health data and the health event. A user interface is in communication with the computing platform and the artificial intelligence application.

In certain embodiments, a method for monitoring a health status of a pet includes providing a health monitoring system including a monitoring device for monitoring a health status of the pet and a computing platform in communication with the monitoring device. The computing platform includes a processor and a first memory on which one or more health modules including tangible, non-transitory, processor executable instructions are stored. The health modules are configured to receive and interpret health data. An artificial intelligence application is in communication with the computing platform and configured to receive the health data and detect a health event. The artificial intelligence application includes a second memory configured to store the health data and the health event. A user interface is in communication with the computing platform and the artificial intelligence application. Additional method steps include creating a pet profile using a pet profile module and health data provided by a user, creating a medical records registry using a medical records module and medical records supplied by the user, securing the monitoring device to the pet, collecting the health data from at least one of the monitoring device and the user, analyzing the health data using at least one of the health modules and the artificial intelligence application, determining whether the health event has occurred, and generating at least one of information, advice, a report, and an alert that is communicated to the user using at least one of the communication module and the artificial intelligence module.

In certain embodiments, a method for monitoring a health status of a pet includes providing a health monitoring system including a monitoring device for monitoring a health status of the pet and a computing platform in communication with the monitoring device. The computing platform includes a processor and a first memory on which one or more health modules including tangible, non-transitory, processor executable instructions are stored. The health modules are configured to receive and interpret health data. An artificial intelligence application is in communication with the computing platform and configured to receive the health data and detect a health event. The artificial intelligence application includes a second memory configured to store the health data and the health event. A user interface is in communication with the computing platform and the artificial intelligence application. Additional steps include collecting respiratory rate data from the monitoring device, calculating, using a controller in communication with the monitoring device, a respiratory rate using the respiratory rate data, and displaying the respiratory rate on the user interface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of a health monitoring system for pets, according to one embodiment;

FIG. 2 is a schematic of a health monitoring system for pets, according to one embodiment;

FIG. 3 is a schematic of a health monitoring system for pets, according to one embodiment;

FIG. 4 is a schematic of a health monitoring system for pets, according to one embodiment;

FIG. 5 is a flow diagram of a method for monitoring a health status of a pet, according to one embodiment;

FIG. 6 is a flow diagram of a method for monitoring a respiratory rate of a pet, according to one embodiment; and

FIG. 7 is a flow diagram of a method for monitoring a respiratory rate of a pet, according to one embodiment.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

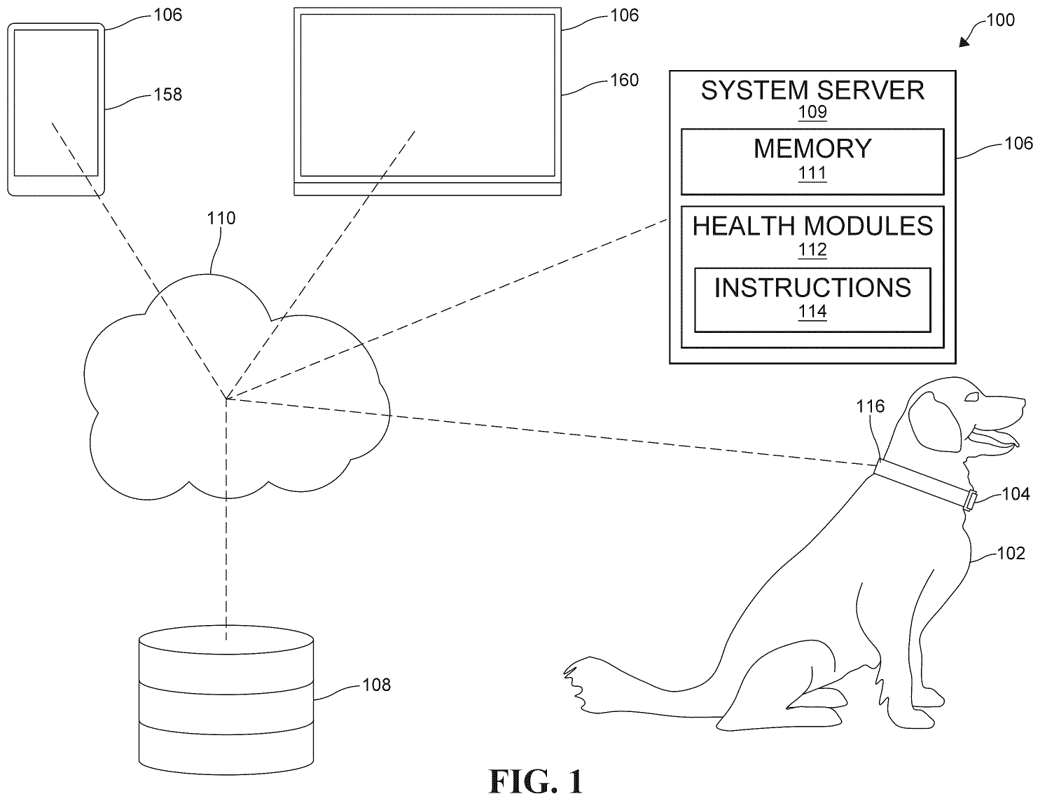

The present technology provides an improved health monitoring system 100 for a pet 102. Embodiments of the health monitoring system 100 and operational aspects thereof are shown generally in FIGS. 1-4. Advantageously, the health monitoring system 100 provides complex data gathering and analysis and generates actionable output for a user to proactively understand, address, and promote pet health. The user may be a veterinarian, a pet owner, a pet healthcare professional, an external or remote user or database, software, artificial intelligence software, a large language model, and/or any combination thereof, as non-limiting examples. In certain embodiments, the health monitoring system 100 may have more than one user.

It should be appreciated that the health monitoring system 100 may rely on both a pet's unique health data including health history, data collected using the health monitoring system 100 and/or the user, statistics and health patterns established by the system 100 or otherwise, behavioral data, text, images, audio files, videos, and any other data specific to the pet's health, as well as general and/or specific population data including health data, statistics, patterns, text, images, audio files, videos, and any other data specific to a general and/or specific population of animals, as non-limiting examples. The population data may be used for comparison and informational purposes and may allow the user to more accurately evaluate health data specific to the pet 102. It should be noted that the health data collected using the health monitoring system 100 may be actionable data that goes beyond mere monitoring. In other words, the health data collected using the health monitoring system 100 may allow for the generation of advice resulting in proactive treatment and monitoring of the pet 102.

With reference to FIG. 1, the health monitoring system 100 may include a monitoring device 104, a computing platform 106, and an artificial intelligence application 108. It should be appreciated that, in certain embodiments, more than one monitoring device 104, computing platform 106, and/or artificial intelligence application 108 may be included in the system 100. One or more users may access the system 100 using the computing platform 106.

In certain embodiments, the system 100 may include at least one computing platform 106 in the form of at least one system server 109. The at least one system server 109 may be communicably coupled with the monitoring device 104 and/or one or more additional computing platforms 106 via at least one network 110. In certain embodiments, a system server memory 111 may store health modules 112 including machine-readable instructions, which may be provided as tangible, non-transitory processor executable instructions 114. It should be appreciated that in certain embodiments, the at least one system server 109 may be provided as either a standalone system or a distributed system with steps distributed across one or more computing platforms 106.

The monitoring device 104 may be configured to monitor various aspects of a health status of a pet 102 by collecting health data. As non-limiting examples, the monitoring device 104 may be or may include a mobile application, a smart collar 116, a software application, a computing platform 106, and any combination thereof. In embodiments where the monitoring device 104 is a smart collar 116, the smart collar 116 may permit continuous tracking of the pet's health status by collecting health data and tracking pet behaviors such as periods of activity and rest, as non-limiting examples.

The monitoring device 104 may include instruments and tools such as an accelerometer 118, a gyroscope 120, and a magnetometer (not shown), as non-limiting examples, used to collect health data from the pet 102 and monitor the health status of the pet 102 continuously, according to a predetermined schedule, initiated as desired by the user, or in programmed intervals determined by the user. In certain embodiments, the monitoring device 104 may be the collar 116, a harness, or other wearable device, an item attached to the collar 116, harness, or other wearable device, equipment connected to any part of the pet's body, and/or any combination thereof, as non-limiting examples, to allow for consistent monitoring and health data collection over time. It should be appreciated that the monitoring device 104 may include any sensors, equipment, tools, and other suitable means for health data collection configured to collect health data from the pet 102, as determined by one of skill in the art.

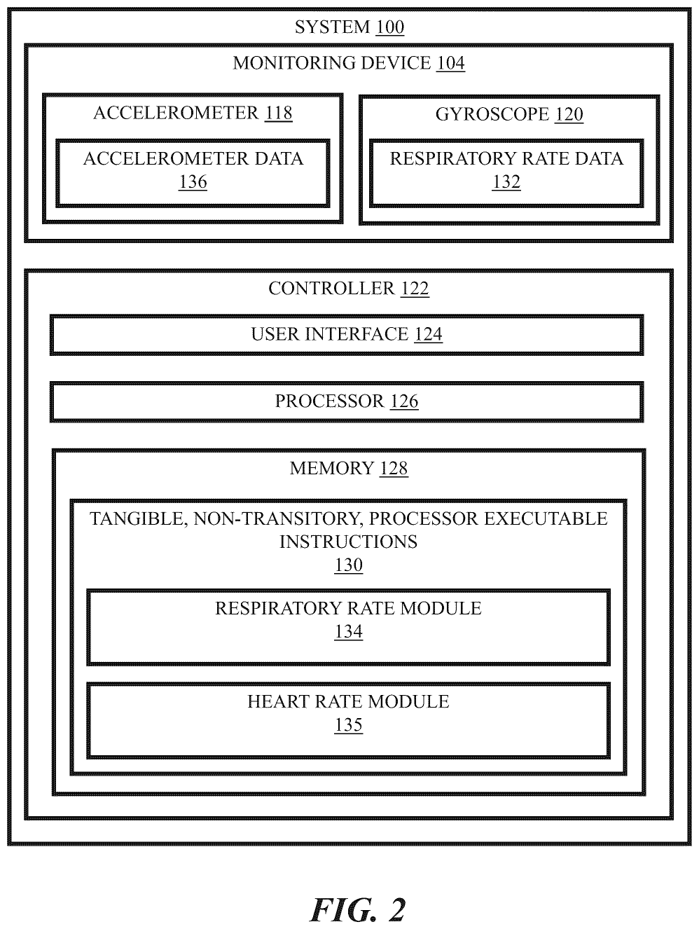

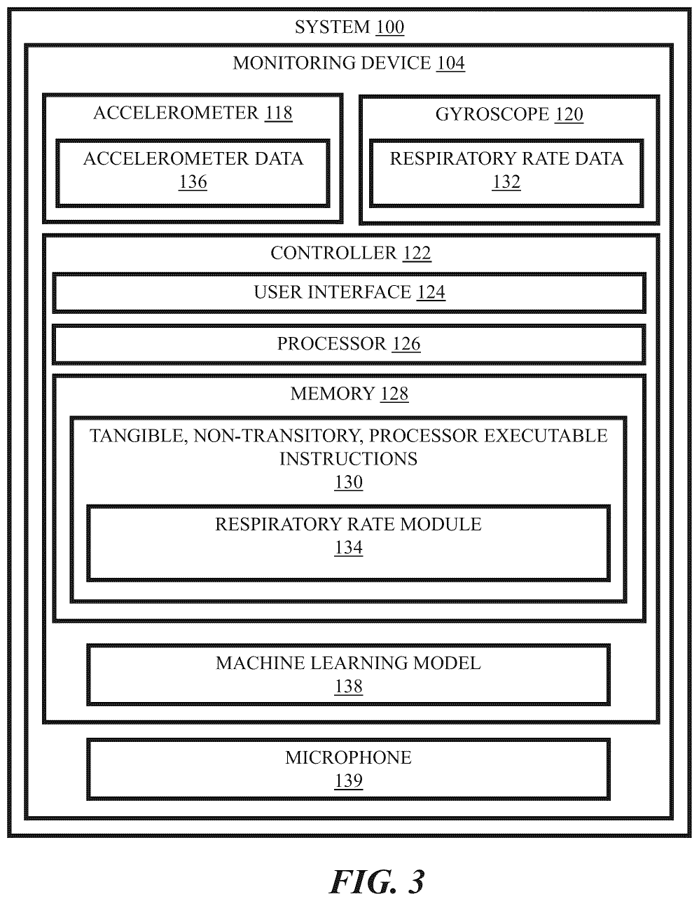

In certain embodiments, as shown in FIGS. 2 and 3, the system 100 may include a controller 122 configured to work with the monitoring device 104. The controller 122 may be integral with, connected to, in communication with, and/or remote from the monitoring device 104, as determined by one of skill in the art. The controller 122 may be configured to receive health data from the sensors and other means for data collection and process the health data to inform the health status of the pet 102 to the user. The controller 122 may be further adapted to manage and control various functions of the monitoring device 104, allowing the user to adjust settings, select what data is displayed, trigger alerts based on the health data, and generally customize the operations of the monitoring device 104, as non-limiting examples.

The controller 122 may include a user interface 124, a processor 126, and a memory 128. The user interface 124 may be configured to display health data, the health status of the pet 102, and any other desired information. The memory 128 may store tangible, non-transitory, processor executable instructions 130, and the processor 126 may execute the tangible, non-transitory, processor executable instructions 130 to receive, store, calculate, analyze, and manipulate health data collected using the monitoring device 104.

In certain embodiments, the tangible, non-transitory, processor executable instructions 130 may be executed by the processor 126 and may be configured to analyze respiratory rate data 132 and calculate a respiratory rate for the pet 102. More specifically, the tangible, non-transitory, processor executable instructions 130 may include a respiratory rate module 134 configured to analyze the respiratory rate data 132 and calculate a respiratory rate for the pet 102. The user interface 124 may be configured to display the calculated respiratory rate for the pet 102.

In another more particular embodiment, the gyroscope 120 may be configured to collect respiratory rate data 132 which may be analyzed to determine the respiratory rate of the pet 102 wearing the monitoring device 104. In operation, as the pet 102 breathes, the gyroscope 120 may measure the movement of the gyroscope 120 for each of an X axis direction, a Y axis direction, and a Z axis direction. The gyroscope 120 may collect and relay the measurement, in the form of respiratory rate data 132, to the controller 122 for analysis. It should be noted that the data collected may be one of angular velocity and, as such, may be measured in degrees per second (°/s).

In another more particular embodiment, health data may be used to determine a normal range with respect to heart rate for different animals using a heart rate module 135. More specifically, health data collected may be used to calculate the normal range on the X axis, the Y axis, and the Z axis. A high pass filter may be applied to the health data for a window of 10 seconds, a power of signal may be calculated, and the peaks within the expected range for heart rate may be counted. A distance between peaks may be calculated and converted to beats per minute. Using the Interquartile Range method, outliers may be isolated and the mean and standard deviation for the beats per minute estimations may be calculated.

In another embodiment, the accelerometer 118 may be used to determine whether the pet 102 is in a resting state by collecting accelerometer data 136 and detecting a state of motion of the pet 102 based on the accelerometer data 136. In order to collect accurate respiratory rate data 132 using the gyroscope 120, the pet 102 may desirably be in a resting state such that the pet 102 is not actively exercising or walking about. As such, the controller 122 may be configured to use the accelerometer data 136 to determine if the pet 102 is in a resting state. If the pet 102 is in a resting state, the respiratory rate data 132 may be processed, however, if the accelerometer data 136 indicates that the pet 102 is not in a resting state, the respiratory rate data 132 may be discarded.

It should be noted that the average difference between peaks and troughs of Euclidean norms (peaks−troughs) of the accelerometer data 136 may provide an accurate representation of whether the pet 102 is in a resting state. Therefore, if the average value is between a max threshold and a low threshold, it may be inferred that the pet 102 is in a resting state and that the respiratory rate data 132 collected is an accurate representation of the respiratory rate of the pet 102. It should be noted that, as used herein, “resting state” or “resting” includes being sedentary or slowly moving. Further, “resting state” or “resting” may include periods during which the pet 102 is conscious such as an awake motionless state or an awake slowly moving state or unconscious such as in a deep sleep state or a light sleep state. It should be appreciated that health data such as the respiratory rate data 132 may be collected by the monitoring device 104, the user, and/or the computing platform 106.

With reference to FIG. 3, in certain embodiments, a machine learning model 138 may be run on or integral with and/or in communication with the monitoring device 104 and may be configured to identify health patterns and make predictions based on the health data collected using the monitoring device 104. The monitoring device 104 may be configured to communicate health data such as vital signs, health patterns, and detected pet behaviors, as non-limiting examples, to the health monitoring system 100 such that further evaluation and analyzation of the health data using the artificial intelligence application 108 may occur.

In certain embodiments, a microphone 139 may be integral with, attached to, or in communication with the monitoring device 104. The microphone 139 may be configured to collect and analyze audible sounds made by one or both of the animal and the user. In non-limiting examples, the microphone 139 may be configured to identify sounds associated with pet behaviors such as licking, barking, drinking, eating, and whimpering. In certain embodiments, the microphone 139 may be configured to receive verbal instructions from the user. In one non-limiting example, the user may provide a verbal instruction to the monitoring device to measure and process the heart rate of the pet 102.

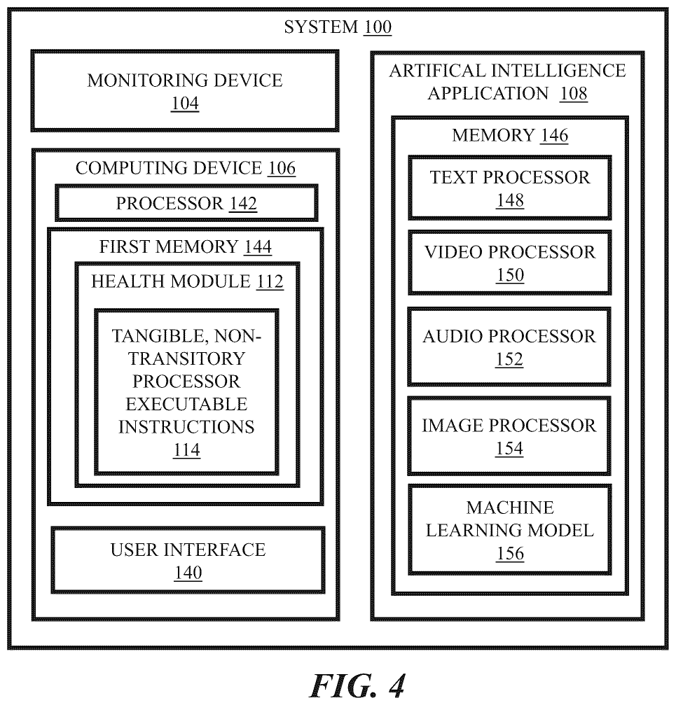

The computing platform 106, as shown in FIG. 4, may include of be in communication with a user interface 140, a processor 142, and a memory 144, as non-limiting examples. In certain embodiments, the computing platform 106 may include an operating system. Applications, such as the artificial intelligence application 108, may be installed and executed using the computing platform 106. Health modules 112 may be stored and executed using the memory 144 and the processor 142 of the computing platform 106. The health modules 112 may include tangible, non-transitory, processor executable instructions 114. The computing platform 106 may be integral with or in communication with the monitoring device 104, the controller 122, other computing platforms 106, the artificial intelligence application 108, and the system server 109, as non-limiting examples, and may be configured to receive, store, analyze, compare, manipulate and display the health data, health status, and health events of the pet 102 using the health modules 112 and the artificial intelligence application 108.

In certain embodiments, the computing platform 106 may include the health modules 112 configured to collect and analyze health data, manage a veterinary practice, organize and manage a pet's health data over the pet's life, receive input including text, audio, images, and videos, provide advice related to a pet's health, educate the user about pet health including, but not limited to, pet behavior and health events, and allow communication between multiple users. The health modules 112 may include at least one of a pet profile module configured to include information about the pet 102 provided by the user, a medical records module configured to store medical records for the pet 102, a health check-up module configured to collect basic health data and schedule health check-ups for the pet 102, a practice management module configured to assist a veterinary professional with practice management, a health data module configured to collect and display health data in the form of text, audio, images, and videos, as non-limiting examples, a health event module configured to determine whether a health event is likely to have occurred, a sleep/activity tracker module, a weight tracker module, a respiratory rate tracker module, a monitoring device module configured to collect and analyze health data from the monitoring device 104, a user input module configured to receive and analyze health data provided by the user and allow the user to establish customized rules and/or parameters with respect to the health data of the pet 102, a population data module configured to receive, analyze, and store population data, a data analyzation module configured to analyze and compare health data, population data, and any other data, a communication module configured to allow communication between users, and an artificial intelligence module configured to analyze and compare health data, population data, and any other data and generate information using the artificial intelligence application 108 and/or a large language model.

It should be appreciated that any number of health modules 112 related to the pet 102, the health data of the pet 102, a larger population of pets and/or animals, the population data, the user, the artificial intelligence application 108 and any related software applications, and the large language model, as non-limiting examples, may be included, as determined by one of skill in the art. Further, one or more of the health modules 112 may be configured to receive, store, evaluate, analyze, and compare any desired health data, population data, and other data, as well as generate information based on any data the system 100 receives and/or stores. The health modules 112 and the tangible, non-transitory processor executable instructions 114 included with the computing platforms 106 of the system 100 may be identical between computing platforms or different, according to different embodiments.

In one more particular example, the health check-up module may be configured to collect health data pertaining to the health status of the pet 102, such as body temperature, respiratory rate, detected pet behaviors and changes in behavior, blood pressure, at or before a health check-up, or according to a predetermined schedule. The health check-up module may be used to provide basic health information to the user prior to a check-up and/or may be used to identify whether a check-up is required based of the health data collected, as non-limiting examples. It should be noted that the health check-up module may be designed to proactively identify potential health concerns based on the health data collected, and as such, collection of health data related to routine health check-ups may be initiated via the monitoring device 104 according to a predetermined schedule and analyzed using the health check-up module. If a more specific assessment of a particular clinical indication is needed to achieve a comprehensive evaluation of the pet's health status based on health data collected for one or more health check-ups, the system 100 may generate additional health check-ups or more frequent or thorough health check-ups as a response. Health data collected during health check-ups may enable a more focused and contextualized understanding of both related and unrelated health events and health data. The pet 102 may undergo a personalized assessment or treatment for a particular ailment, and components of the health data collected during the health check-ups may be utilized to ensure such personalization.

In another more particular embodiment, the sleep/activity tracker module may be configured to collect health data pertaining to the sleep and activity events and/or patterns of the pet 102 over a period of time. The sleep/activity tracker module may include a time-based activity metric that may be viewed as a daily activity goal. The daily activity goal may be expressed as a percentage score, and when a pet 102 reaches 100%, the sleep/activity tracker module may indicate that the pet 102 has successfully met the daily activity goal. It should be noted that, as the daily activity goal may represent a recommended level of activity tailored to each pet 102 for optimal health, it may also further serve as a health status indicator. Should the health data collected by the sleep/activity tracker module indicate that the pet 102 did not reach the daily activity goal for a particular day or for a pre-determined number of days, the user may be notified. In one non-limiting example, the total amount of awake time for a pet 102 may be determined using the sleep/activity tracker module by subtracting the recommended daily sleep duration from a 24 hour period.

The user interface 140 may be integral with and/or in communication with the computing platform 106. The user interface 140 may provide an interface through which the user may view medical records and health data, upload and view text, images, audio files, and videos, describe symptoms and behavior, communicate with the artificial intelligence application 108, generate information and treatment suggestions with respect to a health event or condition, schedule or request appointments, ask questions, and request information, as non-limiting examples. The computing platform 106 may provide updates to the user related to the pet 102 according to a predetermined schedule, during a health event, and upon request by way of the user interface 140.

It should be appreciated that the system 100 may include a plurality of computing platforms 106 and/or one or more remote computing platforms, as determined by one of skill in the art. In certain embodiments, the monitoring device 104 and/or the controller 122 may be a computing platform 106 or in communication with one or more computing platforms 106. In certain more particular embodiments, there may be one or more pet owner computing platforms 158 and one or more health care provider computing platforms 160, as shown in FIG. 1. Each computing platform 106 may be configured to collect, interpret, and analyze health data for a pet 102, inform a user of the health data collected and any health implications, store the health data, alert the user if a health event is detected, and allow the user to communicate with the artificial intelligence application 108 and large language models, as non-limiting examples.

In certain embodiments, the system 100 may be communicatively coupled to one or more remote computing platforms. The communicative coupling may include communicative coupling through a networked environment. The networked environment may be a radio access network, such as LTE or 5G, a local area network (LAN), a wide area network (WAN) such as the Internet, or wireless LAN (WLAN), for example. It should be appreciated that this is not intended to be limiting, and that the scope of this disclosure includes implementations in which one or more computing platforms 106 and remote computing platforms may be operatively linked via some other communication coupling.

The one or more computing platforms 106 may be configured to communicate with the networked environment via wireless or wired connections. In addition, in certain embodiments, a plurality of computing platforms may be configured to communicate directly with one another using wireless or wired connections. Examples of computing platforms may include, but are not limited to, smartphones, wearable devices, tablets, laptop computers, desktop computers, Internet of Things (IoT) devices, or other mobile or stationary devices. In certain embodiments, the system 100 may include one or more hosts or servers, such as the one or more remote computing platforms connected to the networked environment through wireless or wired connections. According to certain embodiment, remote computing platforms may be implemented in or function as base stations (which may also be referred to as Node Bs or evolved Node Bs (eNBs)). In certain embodiments, remote computing platforms may include web servers, mail servers, application servers, etc. According to certain embodiments, remote computing platforms may be standalone servers, networked servers, or an array of servers.

The system 100 may include one or more processors for processing information and executing instructions or operations, including such instructions and/or operations stored on one or more non-transitory mediums. One or more processors may be any type of general or specific purpose processor. In some cases, multiple processors may be utilized according to other embodiments. In fact, the one or more processors may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors may be remote from the one or more computing platforms 106. The one or more processors may perform functions associated with the operation of the system 100 which may include, for example, precoding of antenna gain/phase parameters, encoding and decoding of user bits forming a communication message, formatting of information, and overall control of the one or more computing platforms 106, including processes related to management of communication resources.

The system 100 may further include or be coupled to a memory (internal or external), which may be coupled to one or more processors, for storing information and instructions that may be executed by one or more processors, including any instructions and/or operations stored on one or more non-transitory mediums. The memory may be one or more memories and of any type suitable to the local application environment, and may be implemented using any suitable volatile or nonvolatile data storage technology such as a semiconductor-based memory device, a magnetic memory device and system 100, an optical memory device and system 100, fixed memory, and removable memory. For example, the memory may consist of any combination of random access memory (RAM), read only memory (ROM), static storage such as a magnetic or optical disk, hard disk drive (HDD), or any other type of non-transitory machine or computer readable media. The instructions stored in memory may include program instructions or computer program code that, when executed by one or more processors, enable the one or more computing platforms 106 to perform tasks as described herein.

In some embodiments, one or more computing platforms 106 may also include or be coupled to one or more antennas for transmitting and receiving signals and/or data to and from one or more computing platforms 106. The one or more antennas may be configured to communicate via, for example, a plurality of radio interfaces that may be coupled to the one or more antennas. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

The artificial intelligence application 108 may be in communication with the computing platform 106 and may be configured to detect a health event and provide information and guidance to a user based on the health data collected and/or population data, as non-limiting examples. A health event may be defined as a health anomaly or an instance where the health data collected by the monitoring device 104 or a user, as nonlimiting examples, is abnormal compared to previously collected health data for the pet 102, learning from standard health patterns at scale, population data, data provided by the artificial intelligence application 108, and any combination thereof. In certain embodiments, a health event may be detected if the health data collected falls outside of a normal range, as determined by a pet's health data, population data, stored data, and/or data provided by the artificial intelligence application 108. A health event may also be flagged as such by the user in order to instigate further evaluation using the system 100.

As shown in FIG. 4, the artificial intelligence application 108 may include a memory 146 configured to store health data including but not limited to vital signs, behavioral data, health events, and health patterns for the pet 102, population data, and any other data, as determined by one of skill in the art. The artificial intelligence application 108 may include a text processor 148 configured to process text supplied by the user to the computing platform 106, a video processor 150 configured to process videos supplied by the user to the processor, an audio processor 152 configured to process audio files supplied by the user to the processor, and an image processor 154 configured to process images supplied by the user to the processor.

The artificial intelligence application 108 may include one or more machine learning models 156. The machine learning models 156 may be continually fed with health data and related information for any number of pets, as well as population data, as non-limiting examples. With every pet 102 that is added to the system 100, additional data pertaining to a specific breed, age, symptom, health condition(s), health pattern, health history, and health event may be used to train the machine learning models 156 for future use. As described above, population data such as normal health patterns as established by large populations of pets having specific traits may be used for comparison to assess the health of a pet 102. Once the unique patterns of the pet 102 are established, the artificial intelligence application 108 may identify deviations and attribute significance by integrating the health data of the pet 102 with all other health data related to the pet's traits, behaviors, medical history, and health status, and using the machine learning models 156 that are informed by population data and any other data such as medical records, medical databases, research papers, and case studies, as determined by a skilled artisan. It should be appreciated that outside sources of data in addition to health data and population data may be used to train and fine-tune the machine learning models 156, as determined by one of skill in the art.

It should be appreciated that the artificial intelligence application 108 may assist with health event diagnosis, health data analysis, and treatment recommendations. With respect to diagnosis, the artificial intelligence application 108 may provide symptom analysis to analyze a broad range of symptoms reported by the user and/or detected by the monitoring device 104. Advantageously, the artificial intelligence application 108 may also expand medical knowledge by accessing and interpreting medical databases, research papers, and case studies to aid in diagnosis. The artificial intelligence application 108 may assist by generating scenario simulation to simulate various medical scenarios based on the symptoms and history of the pet 102, therefore helping the user to consider various diagnoses.

The artificial intelligence application 108 may also utilize advanced image recognition algorithms to analyze photos sent by the user. This may involve detecting visual signs of diseases, injuries, or abnormalities. Deep learning provided by the artificial intelligence application 108 may continuously improve the ability of the system 100 to recognize and interpret different conditions and health events, from health data, text, images, audio files, and videos, as non-limiting examples. The artificial intelligence application 108 may rely on a database of images in addition to images submitted by the user. If a concerning observation is detected in an image, the image may be flagged and the user may receive an alert, thereby allowing the user to start treatment or continue monitoring, as needed. The advanced image recognition algorithms utilized by the artificial intelligence application 108 may be configured to identify signs and symptoms of disease and injury.

The health monitoring system 100 may be configured to collect health data provided by the monitoring device 104 and/or the user. In operation, the health data and population data may be used along with the artificial intelligence application 108 and a generative large language module to sequence models based on one or both of health data and population data, generate broad clinical knowledge of a pet's health over the course of the pet's lifetime, and make predictions about the pet's health in the future. With access to population data including medical records, clinical history, lab results, and health data, as non-limiting examples, for thousands of pets 102 that have undergone various types of procedures and surgeries, or that have been diagnosed with a particular condition or disease, a likelihood of a specific outcome or a need for an intervention, such as surgery, as one example, may be predicted.

The artificial intelligence application 108 may read, interpret, and react to the health data collected. The artificial intelligence application 108 may further facilitate conversations between users, answer questions, and ask for additional information via the user interface 140 of the computing platform 106. Real-time updates with respect to the status of the artificial intelligence application 108 analysis during a health event may be accessible to the user via the user interface 140. In a more particular embodiment, the artificial intelligence application 108 may automatically book appointments according to a pet's medical history, a predetermined schedule, user input, health events, and any combination thereof, as non-limiting examples.

It should be appreciated that the analysis done by the artificial intelligence application 108 may be fed into a broader diagnostic algorithm, where certain health data (e.g. health data indicating a health event may have occurred) may be combined with other data (e.g., symptom analysis, medical history, population data) to provide a comprehensive view for the user. Further, the artificial intelligence application 108 may establish a feedback loop where users may provide health data such as user input in the form of text, audio, images, and videos, as non-limiting examples, to the artificial intelligence application 108, allowing the system 100 to learn and improve over time.

In certain embodiments, for the purpose of informing the artificial intelligence application 108, a clinical assessment of what constitutes normal pet behaviors and optimal or normal health data may be conducted. In one non-limiting example, a healthy level of activity for various groups of pets 102 may be determined, drawing from veterinarian clinical experience, medical databases, and other sources of information. Taking into account that optimal activity levels may vary for different animals and animal breeds, a variety of parameters, which may form the basis of a daily activity metric, may be taken into consideration, as determined by one or more users. These parameters may underpin the recommendation for the ideal activity level that best fulfills the needs of the pet 102 to enhance overall health. The daily activity goal may be determined based on a variety of parameters including pet owner goals, veterinarian goals, and goals generated by the artificial intelligence application 108 that may be based on the health data of the pet 102, population data, and other data.

In certain embodiments, health data, population data, and other data may be collected or otherwise provided using one or more of the monitoring device 104, the computing platform 106, one or more health modules 112, the user, text, images, videos, audio files, the artificial intelligence application 108, and large language models, as non-limiting examples. Interpretation, analyzation, and manipulation of the health data, population data, and other data may occur using the computing platform 106, one or more health modules 112, the user, the artificial intelligence application 108, and the large language models, as non-limiting examples. Health data, population data, and other data may include stored data, collected data, data provided by the user, manipulated data, and data provided by the artificial intelligence application 108 and/or large language models.

In one more particular embodiment, a heart rate of the pet 102 may be detected and analyzed using the system 100. Population data may be utilized for comparison purposes, for example, general population data including a normal heart rate range for a type of animal such as a dog and/or specific population data including a normal heart rate range for a specific breed, dog size, weight, gender, or age group, as non-limiting examples. Health data patterns for the pet 102 may also be considered.

In another more particular embodiment, pet behaviors such as shaking, scratching, drinking, limping, licking, eating, sleeping, barking, gaiting, urinating, vomiting, and defecating, as non-limiting examples, that have clinical implications may be detected and analyzed or otherwise identified using one or more of the monitoring device 104, the microphone 139, the user, the computing platform 106, the artificial intelligence application 108, text, videos, audio files, images, and other data. One or more machine learning models 156 may be integral with the monitoring device 104 or in communication with the monitoring device 104, the computing platform 106, and/or the artificial intelligence application 108 and configured to communicate detected behaviors to the monitoring device 104, the computing platform 106, and/or the artificial intelligence application 108. Identified and/or collected health data may be grouped, labeled, or organized automatically by the computing platform 106, the health modules 112, the artificial intelligence application 108, and/or manually by the user.

The system 100 may be configured to periodically establish pet baseline health data and/or pet health patterns with respect to health data and behaviors of the pet 102. The baseline health data, health patterns, user knowledge, population data, artificial intelligence application 108, and large language models may be used independently or in combination with one another to evaluate and compare the pet baseline health data, health data, health patterns, user knowledge, population data, and any additional data to determine if a pet's health data falls within the range of normal and/or whether a particular behavior is considered normal. In certain embodiments, the system 100 may be configured to identify abnormal behaviors, health events, or health patterns. In one non-limiting example, the system 100 may be configured to identify abnormal behaviors related to movement, eating, sleeping, and water consumption independent of external changes such as temperature, location, and activity level of the pet 102. Health data may be evaluated by the user, the computing platform 106, and/or the artificial intelligence application 108 in order to determine if a health event has occurred or if the health data and/or behavior is normal or abnormal.

In certain more particular embodiments, the system 100 may be configured to detect health data related to seizures and alert the user. More specifically, health data related to seizure symptoms such as involuntary movements, muscle contractions, balance issues, drooling, jerking, stiffness, restlessness, vocalizations, and hallucinations may be collected and identified by the user, the computing platform 106, the artificial intelligence application 108, and/or using a machine learning model 156. In certain more particular embodiments, the machine learning model 156 may be integral with the monitoring device 104 and/or the computing platform 106, and health data collected using the accelerometer 118, gyroscope 120, and any other data collection means such as sensors, pet history, user observations, medication errors, images, audio files, and videos, as non-limiting examples, may be merged to detect seizures or identify circumstances that indicate a seizure may have occurred or be likely to occur. It should be appreciated that the system 100 may also be configured to identify a seizure type such as clonic, tonic, tonic-clonic, atonic, myoclonic, and cluster. The system 100 may be further configured to collect health data related to the frequency and timing of seizures. In certain embodiments, the machine learning model 156 that is integral with the collar 116 may be configured to receive health data from the accelerometer 118 and the gyroscope 120, as non-limiting examples, which may indicate or be associated with certain health events such as seizures, as one non-limiting example.

It should be appreciated that the use of images and videos may provide more accurate health data resulting in improved disease identification. Images of the pet's teeth, ears, skin, hair, nose, eyes, paws, and stool, as non-limiting examples, may be evaluated by a user and/or using a large language model with multimodal integration. In certain embodiments, the user may submit a prompt with the image to flag one or more possible issues. The prompt may be an explanation of a particular concern in the form of text or audio or a mark-up of the image such as an arrow pointing to the area of concern, as non-limiting examples. The artificial intelligence application 108, based on evaluation of the image may also be configured to identify and flag issues. It should be appreciated that images and videos may also be submitted as part of routine health check-ups for evaluation.

In one more particular example, an image of a pet's teeth may be evaluated by a user and/or using a large language model with multimodal integration to determine whether the pet 102 has a normal amount of plaque or to identify gum disease, as non-limiting examples. In certain more particular embodiments, the image of a pet's teeth may be evaluated with respect to plaque and tarter buildup, gum health, tooth wear and damage, and abscesses or other abnormal growths, as non-limiting examples, and a severity score may be generated by the artificial intelligence application 108. The severity score may be accompanied by generated text that provides an explanation of the signs and symptoms that the severity score is based on, such as gun inflammation, signs of erosion, and discoloration. Videos may also be submitted and evaluated by the user to identify health events and health issues. In certain embodiments, images and/or videos may trigger a full resolution data collection which may be used to fine tune machine learning models 156 related to behaviors and activity tracing, as non-limiting examples.

In certain embodiments, the system 100 may be configured to provide 24 hour assistance to the user using an on-call veterinary professional, generative artificial intelligence, or a combination thereof via communication online or using text or call functions. Advantageously, the user may access the system 100 at any time, submit health data, review health data, inquire about a pet's health data and any resulting implications, and ask for recommendations with respect to treatment, as non-limiting examples. The system 100 may be configured to use all available health data, population data, and other data such as data included in the artificial intelligence application 108 in combination with the computing platform 106, the artificial intelligence application 108, large language models, and generative artificial intelligence to inform the user. The artificial intelligence application 108 may be configured to read, interpret, and react to health data. facilitate communication between users, answer questions, and request additional health data. In certain embodiment, the artificial intelligence application 108 may be configured to request and schedule appointments based on health data.

As described hereinabove, the system 100 may include the health modules 112 having machine-readable instructions which may be provided as tangible, non-transitory processor executable instructions 114, as a non-limiting example. The machine readable instructions may be configured to execute various methods of the present disclosure, by the system server 109 processor or any other processor included in the system 100 as detailed herein, and as described hereinbelow.

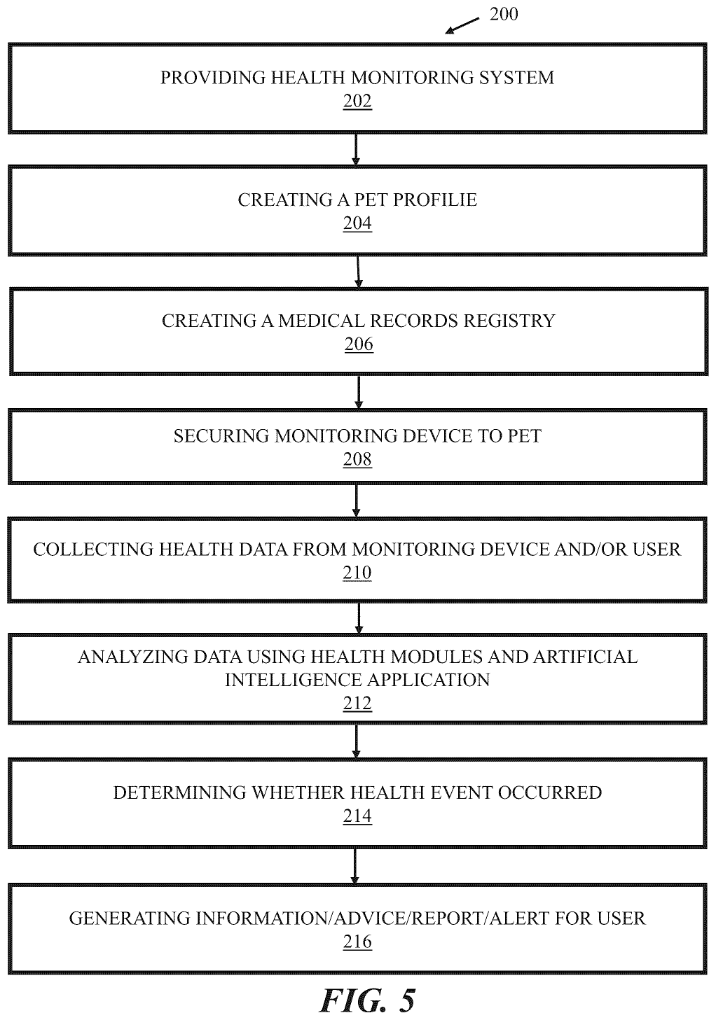

Referring now to FIG. 5, a method 200 for monitoring a health status of a pet 102 may include a first step 202 of providing the system 100 as described hereinabove. In operation, the method 200 may include a second step 204 of creating, using the pet profile module and information provided by the user, a pet profile. In a third step 206, the method may include creating a medical records registry using the medical records module and medical records supplied by the user. Next, the method 200 may include a fourth step 208 of securing the monitoring device 104 to the pet 102, and a fifth step 210 of collecting health data from at least one of the monitoring device 104 and the user, as non-limiting examples.

The method 200 of the present disclosure may include a sixth step 212 of analyzing the health data using the health modules 112, which, according to certain embodiments, may include comparing the health data to previous health data and established health patterns of the pet 102, population data, and any other data using one or more of the health modules 112, the artificial intelligence application 108, and the large language models. Following the analysis, a seventh step 214 may include determining whether a health event has occurred using the health event module alone or in combination with any other applicable health modules 112. The method may then include an eighth step 216 of generating information, advice, reports, and/or an alert for the user using one or more of the communication module, and the artificial intelligence module, as non-limiting examples, based on the health data received.

According to certain embodiments, normal health patterns for large populations of pets 102 having specific traits may be used for comparison to assess a pet's health data and health patterns. Once the unique health patterns are established for the pet 102, the artificial intelligence application 108 may identify deviations and attribute significance by integrating the health patterns established for the pet 102 with other information related to the pet 102 such as traits, medical history, and clinical status with machine learning models 156 that include population data.

In one more particular embodiment, the steps of analyzing health data and determining whether a health event has occurred may actually include a series of steps performed in a predetermined order, as determined by one of skill in the art. More specifically, the health data may initially be compared to past health data specific to the pet 102 such as previous health data and health patterns identified using the medical records registry, the pet profile, and any other previously submitted health data. In the event that analyzation of the health data by comparison to past pet-specific health data indicates that a health event may have occurred, the health data may then be compared to population data in order to determine whether the health data falls within a normal range for a more general pet population and/or the likelihood that a health event has occurred. Finally, should analyzation of the health data by comparison to the population data indicate a health event is likely to have occurred, the health data may then be compared to any other applicable data using the artificial intelligence application 108. If it is again determined that a health event is likely to have occurred, the generative large language model may provide the user with information and advice with respect to addressing the health event. As such, evaluation and analyzation of the health data may be performed in a stepwise sequence primarily considering whether the health data deviates from what is considered normal for the pet 102. It should be appreciated that the user may receive a report, notification, or alert, as non-limiting examples, at any point at which health data is determined to deviate from what is considered normal for the pet 102 and/or for larger pet populations. Likewise, reports and alerts may also be utilized to let the user know when the health data indicates that the health status of the pet 102 is considered normal or healthy.

In certain embodiments, identification of certain health events and behaviors may trigger a request for or automatic collection of additional health data by the system 100. In one non-limiting example, if the pet 102 is losing weight, a request for health data related to eating habits, vomiting, stool consistency, and related behaviors and symptoms may be sent to a user. Upon receipt of the additional health data, the user may evaluate and analyze the health data specific to weight loss and, using the health modules 112 and the artificial intelligence application 108, alert the user and generate information related to the pet's health and advice on how to address health events and other health issues.

Additional steps, such as establishing health patterns and health indicators for the pet 102 or larger populations of pets 102 may also be included in the method 200, as determined by a skilled artisan. Likewise, steps related to deep learning provided by the artificial intelligence application 108 and fine-tuning of the machine learning models 156 may be included to continuously improve the ability of the system 100 to recognize and interpret different diseases, conditions, and health events. In general, it should be appreciated that any steps related to collecting, analyzing, comparing, storing, formulating, processing, and generating health data, population data, and any other data using the health modules 112 may be included in the method 200.

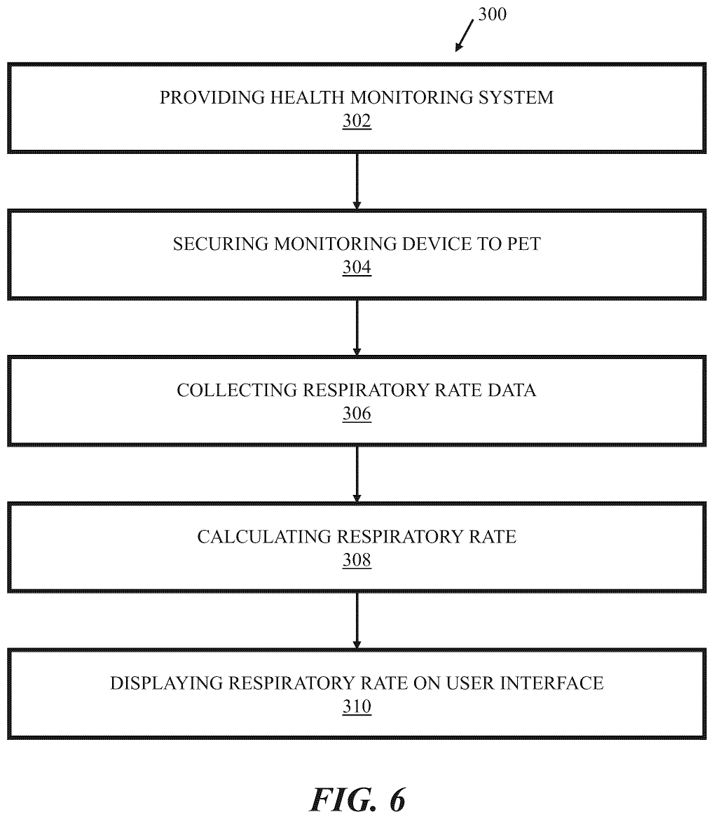

In another more particular embodiment, the present disclosure provides a method 300 for monitoring the respiratory rate of a pet 102, as shown in FIG. 6. The method 300 may include a first step 302 of providing the system 100 as described herein. The method 300 may include a second step 304 of securing the monitoring device 104 to the pet 102. A third step 306 may include collecting respiratory rate data 306 from the monitoring device 104 and a fourth step 308 may include calculating, using the controller 122, the respiratory rate from the respiratory rate data 132. The method 300 may include a step 310 of displaying the respiratory rate on the user interface 124 of the monitoring device 104.

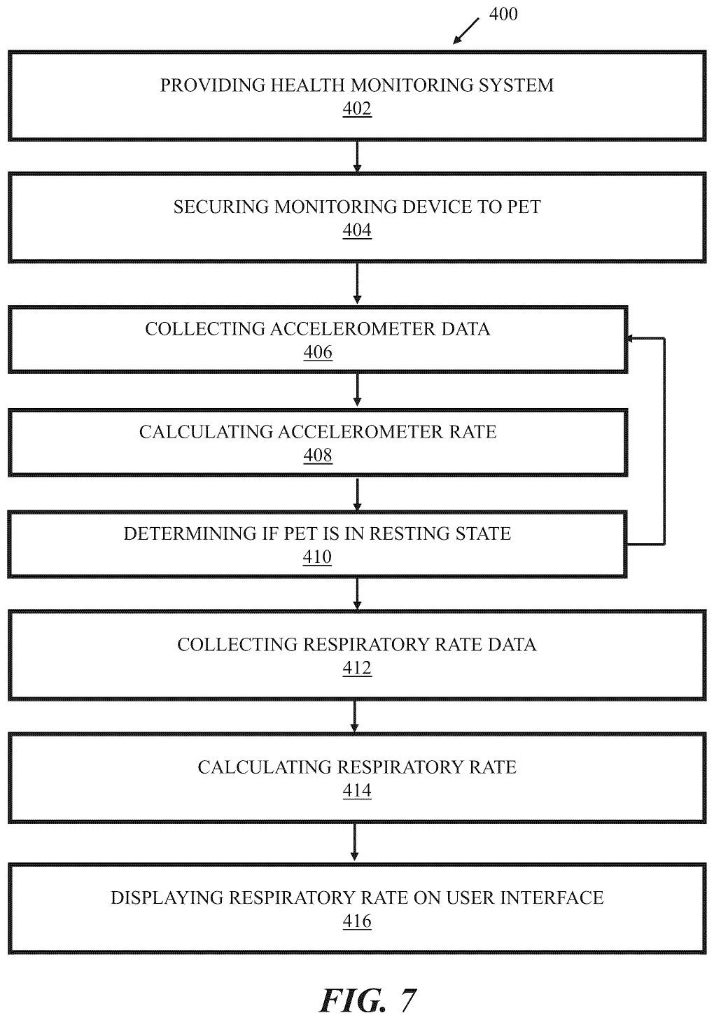

In another embodiment, the present disclosure provides a method 400 for monitoring the respiratory rate of a pet 102, as shown in FIG. 7. The method 400 may include a first step 402 of providing the system 100 as described herein. The method 400 may include a second step 404 of securing the monitoring device 104 to the pet 102. A third step 406 may include collecting accelerometer data 136 from the monitoring device 104, and a fourth step 408 may include calculating an accelerometer rate from the accelerometer data 136. A fifth step 410 may include determining whether the pet 102 is in a resting state based on the accelerometer rate. Where the accelerometer rate indicates that the pet 102 is not in a resting state, the third, fourth, and fifth steps 406, 408, 410 may be repeated until the accelerometer rate indicates that the pet 102 is in a resting state. Once it is determined that the pet 102 is in a resting state, a sixth step 412 may include collecting respiratory rate data 412 from the monitoring device 104, a seventh step 414 may include calculating the respiratory rate from the respiratory rate data 132, and an eighth step 416 may include displaying the respiratory rate 132 on the user interface 124 of the monitoring device 104. As described herein, in order to obtain an accurate respiratory rate for the pet 102, the pet 102 should ideally be in a resting state. As such, when the accelerometer rate indicates that the pet 102 is not in a resting state, the steps 406, 408, 410 related to collecting accelerometer data 136 and calculating the accelerometer rate to determine if the pet 102 is in a resting state may be repeated until the pet 102 is in a resting state. It should be appreciated that the determination of whether the pet 102 is in a resting state or not may be made by comparing the accelerometer data to previously established health data and health patterns for the pet 102, and/or population data, as non-limiting examples. It should also be appreciated that, in certain embodiments, respiratory rate data 132 may be collected before the accelerometer rate is calculated and discarded if it is determined that the pet is not in a resting state.

Advantageously, the system 100 of the present disclosure allows for the respiratory rate of a pet 102 to be monitored without the intervention of any human being. Additionally, the system 100 may be small with low computation power to allow for estimating the respiratory rate without highly complex algorithms. Finally, the system 100 may calculate the respiratory rate in the system 100 itself thereby avoiding sending sensor data to an external source for analysis.

It should be appreciated that additional steps may be included in the methods 200, 300, 400. Likewise, certain steps may be omitted and/or the order of the steps may vary. Steps may also be repeated, as needed.

Although the present disclosure is described primarily with respect to the system 100 and methods 200, 300, 400 it should be appreciated that, being computer-implemented in scope, the system 100 and methods 200, 300, 400 may both also have a non-transient computer-readable storage medium in the form of the at least one memory of a system server, comprising the instructions being executable by the one or more processors to perform the methods 200, 300, 400 as described herein.

It should be appreciated that the present disclosure may include a multitude of hardware and software components that communicate with each other. Through the use of the monitoring device 104, user input, and the artificial intelligence application 108, health data such as vital signs and pet behaviors of the pet 102, as non-limiting examples, may be quantified and/or categorized into one or more datasets. The datasets may then be translated into health patterns related to behavior and lifestyle patterns, as non-limiting examples, and utilized and/or evaluated as health indicators to determine a health status of the pet 102 and whether a health event has occurred.

It should be appreciated that health data collected and stored for a pet 102 may include pet history, pet activity, pet behavior, events, user observations, inquiries, and any other useful information that may indicate the health status of the pet 102. In this way, any device or hardware that may be configured to collect health data pertaining to any health statistic, pattern, behavior, event, occurrence, and the like for any type of animal may be utilized according to this system 100. A skilled artisan may select any suitable means for collecting health data for a pet 102 or animal within the scope of the present disclosure.

In certain embodiments, the system 100 may integrate information contained in a vet practice management software utilized by the user providing health care. In this way, the system 100 may be configured to automatically collect all the information pertaining to the pet 102, such as medical records, medication, surgeries, and exams, as non-limiting examples. As such, from the moment that the user starts using the system 100, the information provided by the in the vet practice management software may be utilized in combination with the artificial intelligence application 108, thereby allowing the artificial intelligence application 108 to know the same information that the user providing health care knows. Advantageously, the health monitoring system 100 provides complex data gathering and analysis. The medical records registry and pet profile may be retrieved by any user at any time, as well as the most up-to-date health data collected for the pet 102, thereby ensuring that each user always has complete, up-to-date, identical, and accurate information for the pet 102. The system 100 allows for in-depth tracking and follow-up of the pet's health data by pet owners and veterinary professionals alike, and the artificial intelligence application 108 provides in-depth, personalized, accurate, updated, and actionable analyzation and feedback with respect to the health data, on demand.

It should be appreciated that the health monitoring system 100 may rely on both a pet's health data including statistics and health patterns specific to the pet 102 as well as population data including health statistics and health patterns attributable to the population as a whole for comparison purposes in order to better analyze the pet health data and provide more accurate output. Desirably, the present invention generates actionable output for a user to proactively address and promote pet health.

More specifically, analysis of the health data collected using the system 100 in combination with the artificial intelligence application 108 and the health modules 112 results in generated information and advice that the user may use to address specific health events, conditions, and diseases. Desirably, the health monitoring system 100 provides personalized, accurate, optimal, and continuous care for pets 102 and enhanced practice efficiency for veterinarians. Users including pet owners, veterinary professionals, and large language models may communicate with one another, request information, provide health data, answer questions, and suggest specific actions in real time, thereby optimizing pet health care.

### EXAMPLES

Example embodiments of the present technology are provided herewith.

In one example embodiment, the health monitoring system 100 may be used in a veterinary practice to improve pet health care for all pets 102 seen by the veterinary practice. Initially, the veterinarian(s) and support staff may integrate other software applications and/or databases already in use at the veterinary practice, such a billing software, scheduling software, and medical records, as non-limiting examples, with the pet health monitoring system 100, such that all information relating to each pet 102 is accessible using the health monitoring system 100. Likewise, pet owners may submit health history, medical records, and general information about the pet 102.

The health history, health data, health events, and all other data related to the pet is accessible to all users such as the veterinary professionals, the pet owner(s), and the artificial intelligence application 108 at all times using the computing platform 106. As such, all users operate using the same information, and the system allows all of the users to communicate in real time with one another about the pet 102, with each user having the most up-to-date information. The monitoring device 104 may be worn by the pet 102 in order to provide the health status of the pet continuously or in predetermined intervals, as determined by the veterinary professionals, the pet owner, or the artificial intelligence application 108. Baseline health data may be obtained so that normal ranges and health patterns may be established for the pet 102. For healthy pets, the monitoring device 104 may collect predetermined or routine health data to be analyzed using the health check-up module in order to determine whether a health check-up may be required, in one non-limiting example. Should the predetermined health data indicate that a check-up may be required to address a possible health event, the system 100 may initiate contact between the pet owner and the veterinary professionals.

For pets experiencing symptoms or health events, the monitoring device 104 may be configured to collect routine health data and/or health data that may be related to the symptoms or health events, as determined by one or more users. Text, images, audio files, and videos describing or showing pet behavior, symptoms, and health events, as non-limiting examples, may be submitted by the user for analyzation using the computing platform 106 and the artificial intelligence application 108. Images and videos may provide more detailed and accurate health data resulting in improved disease and health event identification. Images of the pet's teeth, ears, skin, hair, nose, eyes, paws, and stool, as non-limiting examples, may be evaluated by one or more of the veterinary staff, the artificial intelligence application 108, and large language models using multimodal integration. Health data obtained from the monitoring device 104 may be used in combination with all other health data in order to determine which health events may need to be addressed.

Advantageously, the generative large language model may provide information, and recommendations regarding the health of the pet 102 and potential treatments to the pet owner and the veterinary professionals. The machine learning models 156 that are integral with one or more of the monitoring device 104, the computing platform 106, and the artificial intelligence application 108 allow for optimized and ever-improving identification and analysis of health data, pet behaviors and health events. Pet owners and a veterinary professional may utilize the system 100 to track, analyze, and communicate about a pet. Each user may view medical records and health data, upload, view, and evaluate text, images, audio files, and videos, describe symptoms and behavior, communicate with other users, generate information and treatment suggestions with respect to health events and conditions, schedule or request appointments, ask questions, and request information, as non-limiting examples. As a result, health care provided to the pet 102 is comprehensive, personalized, and optimal.

In a more particular embodiment, an example of a respiratory rate determination from the respiratory rate data 132 utilizing the respiratory rate module 134 is shown. Upon collecting the respiratory rate data 132 from the gyroscope 120, the respiratory rate module 134 detects the movements along each of the X axis, the Y axis, and the Z axis. The respiratory rate module 134 may remove noise from the respiratory rate data 132 collected thereby providing a more accurate calculation of the respiratory rate of the pet 102. The respiratory rate module 134 may perform a Fast Fourier Transform to convert the respiratory rate data 132 from a measurement of angular velocity with a unit of degrees per second (°/s), as collected by the gyroscope 120, to a measurement of frequency with a unit of Hertz. The respiratory rate module 134 may filter the respiratory rate data 132 to exclude frequencies below, for example, 1 Hertz. It should be noted that frequencies below 1 Hertz are not relevant for determining respiratory rate. A skilled artisan may select any suitable frequency for the respiratory rate data 132 within the scope of the present disclosure.

The respiratory rate module 134 may identify the most and second most significant frequency in the respiratory rate data 132, and using the two frequencies, calculate the weight of the two peak frequencies respective to the entire respiratory rate data 132. Where the highest frequency falls below a predetermined minimum threshold or the second highest frequency exceeds a predetermined maximum threshold, the respiratory rate may be considered invalid and new respiratory rate data 132 may be collected. Where the highest frequency exceeds a predetermined minimum threshold and the second highest frequency falls below a predetermined maximum threshold, the respiratory rate data 132 may be considered valid and the respiratory rate module may calculate breathes per minute based on the highest peak.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. A health monitoring system for a pet, comprising:
a monitoring device for monitoring a health status of the pet;
a computing platform in communication with the monitoring device and having a processor and a first memory on which health modules including tangible, non-transitory, processor executable instructions are stored, the health modules configured to receive and interpret health data;
an artificial intelligence application in communication with the computing platform and configured to receive the health data and detect a health event, the artificial intelligence application including a second memory configured to store the health data and the health event; and
a user interface in communication with the computing platform and the artificial intelligence application.

2. The health monitoring system of claim 1, wherein the monitoring device includes one of a mobile application, a smart collar, and a veterinary software.

3. The health monitoring system of claim 1, wherein the health modules include at least one of a pet profile module, a health check-up module, a health data module, a health event module, a weight tracker module, a respiratory rate tracker module, a monitoring device module, a sleep/activity tracker module, a user input module, a population data module, a data analyzation module, a communication module, and an artificial intelligence module.

4. The health monitoring system of claim 1, wherein the health monitoring system is configured for use by a user, and wherein the user is one or more of a veterinarian, a pet owner, a pet healthcare professional, an external or remote user or database, a software, the artificial intelligence application, and a large language model.

5. The health monitoring system of claim 4, wherein the health monitoring system is configured for use by a plurality of users, and wherein the plurality of users includes at least a veterinarian, a pet owner, and the artificial intelligence application.

6. The health monitoring system of claim 1, wherein a machine learning model is integral with the monitoring device.

7. The health monitoring system of claim 1, wherein the monitoring device includes a gyroscope that is configured to collect respiratory rate data and a controller that is configured to calculate a respiratory rate based on the respiratory rate data.

8. The health monitoring system of claim 7, wherein the monitoring device includes an accelerometer that is configured to determine whether the pet is in a resting state by collecting accelerometer data and detecting a state of motion of the pet based on the accelerometer data, and wherein the respiratory rate data is one of processed and discarded base on the accelerometer data.

9. The health monitoring system of claim 3, wherein the health check-up module may be configured to collect the health data pertaining to the health status of the pet at one of before a health check-up or according to a predetermined schedule.

10. The health monitoring system of claim 3, wherein the sleep/activity tracker module includes a time-based activity metric that is displayed as a daily activity goal on the user interface.

11. The health monitoring system of claim 1, wherein at least one health module is configured to receive and analyze the health data and determine whether the health event has occurred.

12. The health monitoring system of claim 1, wherein the artificial intelligence application is configured to receive and analyze the health data and determine whether the health event has occurred.

13. The health monitoring system of claim 4, wherein the artificial intelligence application includes a video processor configured to process videos supplied by the user to the processor and an image processor configured to process images supplied by the user to the processor.

14. The health monitoring system of claim 13, wherein the artificial intelligence application utilizes advanced image recognition algorithms to process and analyze the images and the videos supplied by the user.

15. The health monitoring system of claim 1, wherein the artificial intelligence application includes at least one machine learning model configured to continually receive the health data and population data.

16. The health monitoring system of claim 1, wherein at least one health module and the artificial intelligence application is configured to compare the health data and population data to determine whether the health event has occurred.

17. The health monitoring system of claim 1, wherein the health monitoring system is configured to provide 24 hour assistance using a generative large language model.

18. The health monitoring system of claim 1, wherein the health monitoring system is configured to periodically establish a pet baseline using the health data.

19. A method for monitoring a health status of a pet, comprising:
providing a health monitoring system including:
a monitoring device for monitoring a health status of the pet;
a computing platform in communication with the monitoring device and having a processor and a first memory on which health modules including tangible, non-transitory, processor executable instructions are stored, the health modules configured to receive and interpret health data;
an artificial intelligence application in communication with the computing platform and configured to receive the health data and detect a health event, the artificial intelligence application including a second memory configured to store the health data and the health event; and
a user interface in communication with the computing platform and the artificial intelligence application;
creating a pet profile using a pet profile module and health data provided by a user;
creating a medical records registry using a medical records module and medical records supplied by the user;
securing the monitoring device to the pet;
collecting the health data from at least one of the monitoring device and the user;
analyzing the health data using at least one of the health modules and the artificial intelligence application;
determining whether the health event has occurred; and
generating at least one of information, advice, a report, and an alert for the user.

20. A method for monitoring a health status of a pet, comprising:
providing a health monitoring system including:
a monitoring device for monitoring a health status of the pet;
a computing platform in communication with the monitoring device and having a processor and a first memory on which health modules including tangible, non-transitory, processor executable instructions are stored, the health modules configured to receive and interpret health data;
an artificial intelligence application in communication with the computing platform and configured to receive the health data and detect a health event, the artificial intelligence application including a second memory configured to store the health data and the health event; and
a user interface in communication with the computing platform and the artificial intelligence application;
securing the monitoring device to the pet;
collecting respiratory rate data from the monitoring device;
calculating, using a controller in communication with the monitoring device, a respiratory rate using the respiratory rate data; and
displaying the respiratory rate on the user interface.
